(19) United States
(12) Patent Application Publication
(10) Pub. No.: US 2021/0234858 A1
(43) Pub. Date: Jul. 29, 2021

(54) AUTHENTICATION SYSTEM, AUTHENTICATION METHOD AND AUTHENTICATION APPARATUS

(71) Applicant: Capy Japan Inc., Tokyo (JP)

(72) Inventors: Kazuhiro NAKAGAWA, Tokyo (JP); Takanobu WATANABE, Tokyo (JP); Mitsuo OKADA, Tokyo (JP)

(73) Assignee: Capy Japan Inc., Tokyo (JP)

(21) Appl. No.: 17/213,204

(22) Filed: Mar. 25, 2021

Related U.S. Application Data
(63) Continuation of application No. PCT/JP2018/036928, filed on Oct. 2, 2018.

(51) Int. Cl. H04L 29/06; H04L 29/08

(52) U.S. Cl. CPC H04L 63/0861; H04L 67/26; H04L 63/20; H04L 63/0876

(57) ABSTRACT

In the authentication system, the application server includes an authentication requesting part that sends biometric authentication request information to an authentication server for requesting biometric authentication for the user, and a providing part that provides a function related to the application when the authentication succeeds, the authentication server includes a biometric authentication instructing part that sends a push notification including first instruction information to a mobile terminal, which is possessed by the user, when the biometric authentication request information is received, first instruction information instructing performance of the biometric authentication corresponding to the service ID included in said biometric authentication request information, and a result sending part that sends the authentication result to the application server that sent the biometric authentication request information when an authentication result of the biometric authentication corresponding to the first instruction information received from the mobile terminal.

### CROSS-REFERENCE TO RELATED APPLICATIONS

The present application is a continuation application of International Application No. PCT/JP2018/036928, filed on Oct. 2, 2018. The contents of this application are incorporated herein by reference in their entirety.

### BACKGROUND OF THE DISCLOSURE

The present disclosure relates to an authentication system, an authentication method, and an authentication apparatus.

In recent years, there has been an increasing number of cases in which biometric authentication is used as an alternative to conventional password authentication in authentication of Web sites that provide applications such as Web applications. As an authentication mechanism using biometric authentication, Fast IDentity Online (FIDO) Universal Authentication Framework (UAF) has been attracting attention, and compliant products have also been developed. Japanese Unexamined Patent Application Publication No. 2017-152880 discloses a technique related to FIDO.

FIDO UAF is highly secure and effective because it does not require biometric data to be stored on a server. However, if application developers want to implement FIDO UAF, they need to install an authentication server that performs FIDO UAF-compliant processing, which creates a high barrier to implementation.

### BRIEF SUMMARY OF THE DISCLOSURE

The present disclosure focuses on these points and provides an authentication system, an authentication method, and an authentication apparatus capable of easily handling a result of biometric authentication in an application server.

An authentication system according to the first aspect of the present disclosure includes a plurality of application providing devices that provides applications, and an authentication apparatus that performs biometric authentication for a user who uses the applications, wherein the application providing device includes an authentication requesting part that sends biometric authentication request information to the authentication apparatus when a request for authentication for the user is received from a terminal, the biometric authentication request information including service identification information for identifying the application providing device and requesting biometric authentication for the user, and a providing part that provides a function related to the application to the terminal when an authentication result of the biometric authentication is received from the authentication apparatus and the authentication result indicates that the biometric authentication was successful, the authentication apparatus includes a biometric authentication instructing part that sends a push notification including first instruction information to a mobile terminal, which is possessed by the user and capable of performing biometric authentication, when the biometric authentication request information is received, the first instruction information instructing performance of the biometric authentication corresponding to service identification information included in the biometric authentication request information, a verifying part that receives the authentication result of the biometric authentication corresponding to the first instruction information from the mobile terminal and verifies the validity of the authentication result, and a result sending part that sends the authentication result to the application providing device that sent the biometric authentication request information when the verification part verifies that the authentication result is valid.

An authentication method according to the second aspect of the present disclosure is an authentication method performed by an authentication system including a plurality of application providing devices that provides applications and an authentication apparatus that authenticates a user using the applications, the authentication method including the steps of sending, when the application providing device receives an authentication request for the user from a terminal, biometric authentication request information including service identification information for identifying the application providing device and requesting biometric authentication for the user to the authentication apparatus, sending a push notification to a mobile terminal which is possessed by the user and capable of performing biometric authentication, the push notification including first instruction information that instructs performance of the biometric authentication corresponding to service identification information included in the biometric authentication request information, when the authentication apparatus receives the biometric authentication request information, receiving an authentication result of the biometric authentication corresponding to the first instruction information from the mobile terminal and verifying the validity of the authentication result by the authentication apparatus, sending the authentication result to the application providing device that sent the biometric authentication request information, by the authentication apparatus, when the authentication apparatus verifies that the authentication result is valid, and providing a function related to the application to the terminal when the application providing device receives the authentication result of the biometric authentication from the authentication apparatus and the authentication result indicates that the biometric authentication was successful.

An authentication apparatus according to the third aspect of the present disclosure is an authentication apparatus that performs biometric authentication for a user, including a biometric authentication instructing part that, when receiving biometric authentication request information from the application providing device providing applications, sends a push notification to a mobile terminal, which is possessed by the user and capable of performing biometric authentication, the push notification including instruction information that instructs performance the biometric authentication corresponding to service identification information, the biometric authentication request information including the service identification information for identifying the application providing device providing applications and requesting biometric authentication for the user, a verifying part that receives an authentication result of the biometric authentication corresponding to the instruction information from the mobile terminal and verifies the validity of the authentication result, and a result sending part that, when the verifying part verifies that the authentication result is valid, sends the authentication result to the application providing device that sent the biometric authentication request information.

### BRIEF DESCRIPTION OF THE DRAWINGS

FIG. 1 shows a configuration of an authentication system according to the embodiment.

FIG. 2 schematically shows functional configurations of an authentication server and an application server according to the embodiment.

FIG. 3 is a sequence diagram showing processing when the authentication server according to the embodiment registers a user.

FIG. 4 shows a sequence following FIG. 3.

FIG. 5 illustrates an example of a user registration screen.

FIG. 6 illustrates an example of a registered service screen showing services for which user registration has been performed.

FIG. 7 is a sequence diagram showing processing when authenticating a user in the authentication system according to the embodiment.

FIG. 8 shows a sequence following FIG. 7.

FIG. 9 illustrates a mobile terminal displaying information indicating that the user has been successfully authenticated.

FIG. 10 schematically shows a variation of functional configurations of the authentication server and the application server of the embodiment.

### DETAILED DESCRIPTION OF THE DISCLOSURE

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### [An Outline of an Authentication System S]

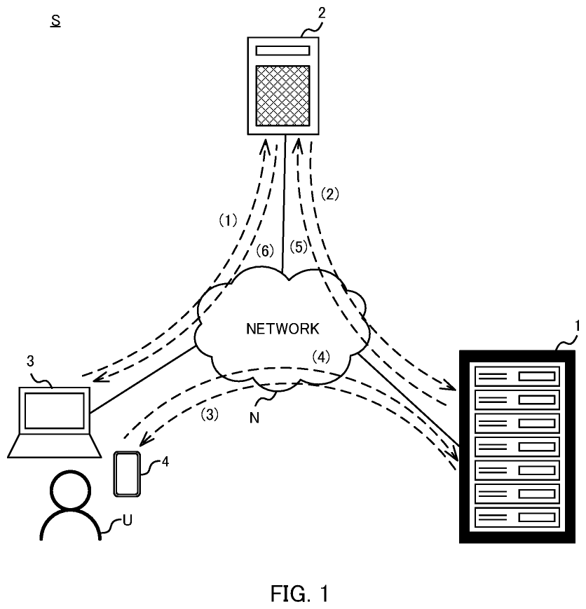

FIG. 1 shows a configuration of an authentication system S according to the embodiment. The authentication system S is a system that includes an authentication server 1 as an authentication apparatus, an application server 2 as an application providing device, a terminal 3, and a mobile terminal 4, and performs biometric authentication.

The terminal 3 is, for example, a personal computer used by a user U. The mobile terminal 4 is, for example, a mobile phone such as a smart phone, and can perform the biometric authentication such as fingerprint authentication.

The terminal 3 and the mobile terminal 4 can communicate with the authentication server 1 and the application server 2 through a network N such as a LAN, a mobile telephone line network, or Wi-Fi (registered trademark).

The authentication server 1 is a server that performs the biometric authentication for the user U using the mobile terminal 4.

The application server 2 is a server that provides an application to the terminal 3. In the embodiment, it is assumed that there is a plurality of application servers 2.

Hereinafter, the procedures of processing performed in the authentication system S will be described in (1) through (6), which correspond to (1) through (6) shown in FIG. 1. (1), (2) When the application server 2 receives an authentication request from the terminal 3, the application server 2 requests the authentication server 1 to perform the biometric authentication on the user of the terminal 3.

(3) When the authentication server 1 receives a request from the application server 2 for the biometric authentication for the user of the terminal 3, the authentication server 1 sends, to the mobile terminal 4, a push notification including instruction information that instructs performance of the biometric authentication to make the mobile terminal 4 perform the biometric authentication.

(4), (5) The authentication server 1 acquires an authentication result of the biometric authentication from the mobile terminal 4, and sends the authentication result to the application server 2 when the authentication server 1 confirms that the authentication result is valid.

(6) The application server 2 provides the user U with a function related to the application when the authentication result received from the authentication server 1 indicates that biometric authentication was successful.

When having the user U perform the biometric authentication when authenticating user U on the application server 2, an operator of the application server 2 only needs to implement i) a function of performing processing related to a biometric authentication request and ii) a function of acquiring the authentication result. In this way, the operator of the application server 2 can easily handle the result of biometric authentication in the application server 2.

### [Functional Configurations of the Authentication Server 1 and the Application Server 2]

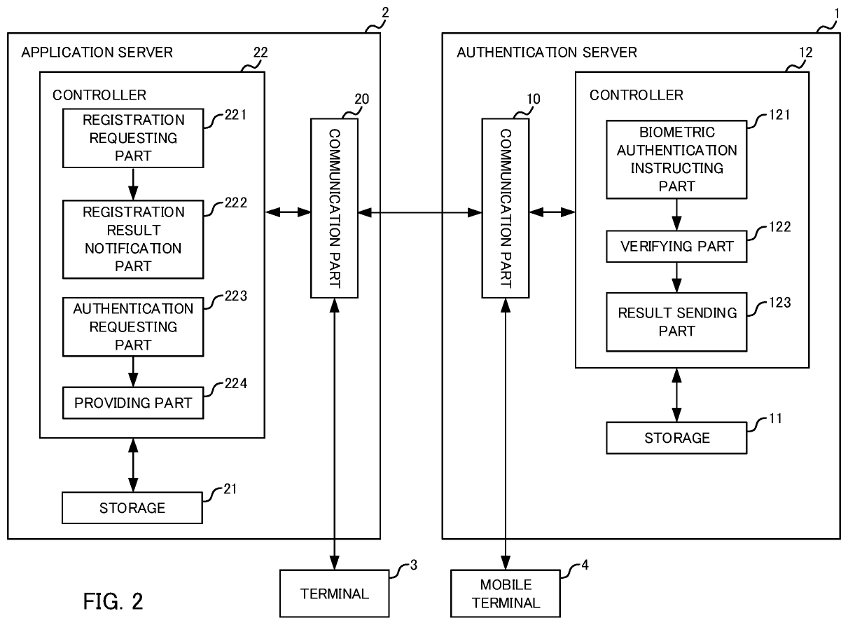

A functional configuration of the authentication server 1 and a functional configuration of the application server 2 will be described below with reference to FIG. 2. FIG. 2 schematically shows the functional configurations of the authentication server 1 and the application server 2 according to the embodiment.

As shown in FIG. 2, the authentication server 1 includes a communication part 10, a storage 11, and a controller 12. The communication part 10 sends and receives data to and from the application server 2 and the mobile terminal 4 through the network N. The storage 11 is a mass storage device such as a Read Only Memory (ROM) for storing a Basic Input Output System (BIOS) of a computer that realizes the authentication server 1, a Random Access Memory (RAM) that serves as a work area of the authentication server 1, and a Hard Disk Drive (HDD) and a Solid State Drive (SSD) for storing various types of information including an Operating System (OS) and an application program, and various databases referenced when executing said application program.

The controller 12 is a processor such as a Central Processing Unit (CPU) or a Graphics Processing Unit (GPU) of the authentication server 1. The controller 12 functions as a biometric authentication instructing part 121, a verifying part 122, and a result sending part 123 by executing the program stored in the storage 11.

Further, as shown in FIG. 2, the application server 2 includes a communication part 20, a storage 21, and a controller 22.

The communication part 20 sends and receives data to and from the authentication server 1 and the terminal 3 through the network N.

The storage 21 is a mass storage device such as a ROM for storing a BIOS of a computer that realizes the application server 2, a RAM that serves as a work area of the application server 2, and an HDD and an SSD for storing various information including an OS and an application program, and various databases referenced when executing said application program. The storage 21 stores a program for authentication for causing the controller 22 to function as a registration requesting part 221, a registration result notification part 222, an authentication requesting part 223, and a providing part 224.

The controller 22 is a processor such as a CPU or a GPU of the application server 2, and functions as the registration requesting part 221, the registration result notification part 222, the authentication requesting part 223, and the providing part 224 by executing the program stored in the storage 21.

[Registration of a User with the Authentication Server 1]

In the embodiment, the registration requesting part 221 of the application server 2 requests the authentication server 1 to register the user U when the registration requesting part 221 receives a request for registering the user U with the authentication server 1 from the mobile terminal 4 used by the user U.

The biometric authentication instructing part 121 of the authentication server 1 instructs the mobile terminal 4 to perform the biometric authentication when the biometric authentication instructing part 121 receives the request for registering the user U. When the verifying part 122 receives the authentication result of the biometric authentication from the mobile terminal 4, the verifying part 122 verifies the validity of the authentication result. When the authentication result of the biometric authentication is verified to be valid, the result sending part 123 registers the user U.

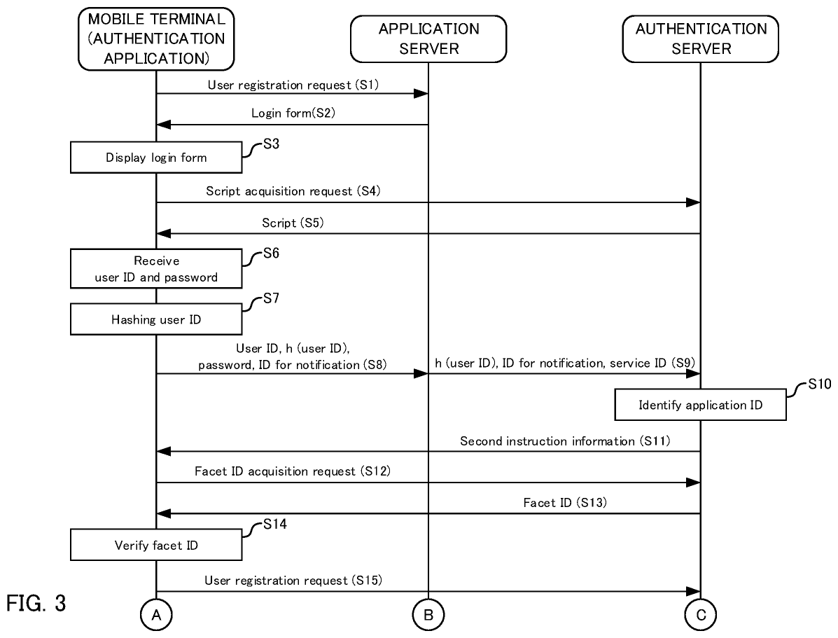

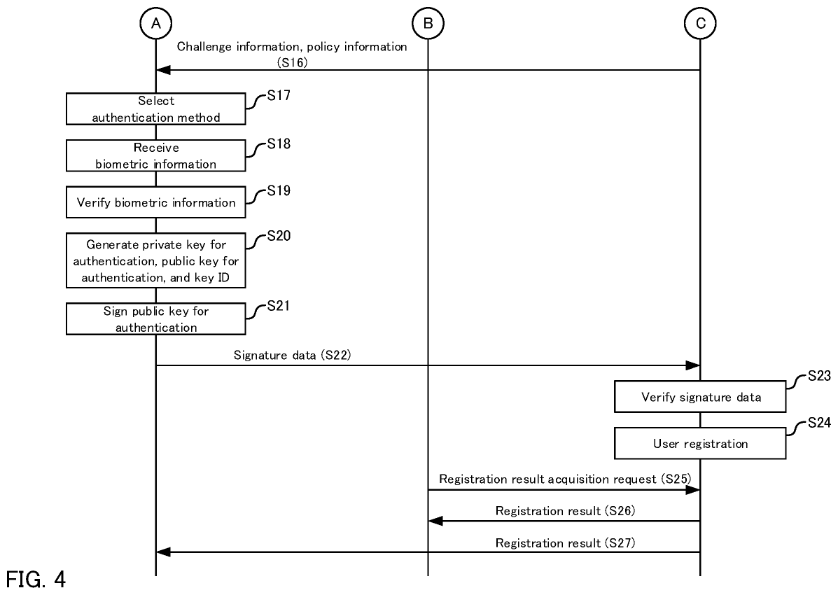

A function of registering the user U with the authentication server 1 will be described in detail below along a sequence in the authentication system S. FIG. 3 and FIG. 4 are sequence diagrams showing processing when the authentication server 1 according to the embodiment registers the user U.

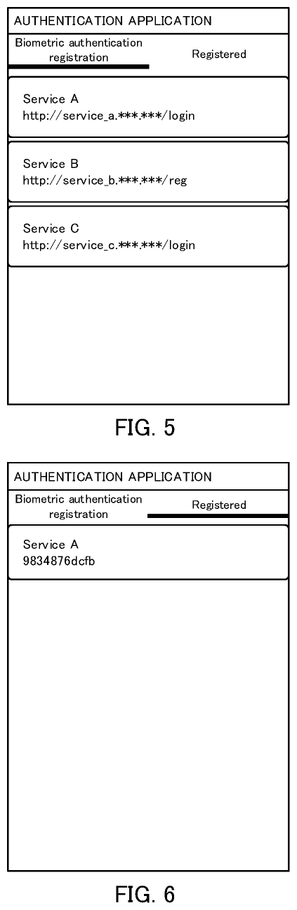

First, the registration requesting part 221 of the application server 2 receives a user registration request from the mobile terminal 4 (step S1). An authentication application which performs the biometric authentication and cooperates with the authentication server 1 is installed in the mobile terminal 4. When the mobile terminal 4 executes the authentication application, the mobile terminal 4 displays a screen of the authentication application. FIGS. 5 and 6 are drawings showing examples of the screen of the authentication application according to the embodiment. FIG. 5 illustrates an example of a user registration screen.

FIG. 6 illustrates an example of a registered service screen showing services for which user registration has been performed. The screens shown in FIGS. 5 and 6 have a tab labeled “biometric authentication registration” and a tab labeled “registered.” The authentication application of the mobile terminal 4 displays the screen shown in FIG. 5 when the tab labeled “biometric authentication registration” is selected. The authentication application of the mobile terminal 4 displays the screen shown in FIG. 6 when the tab labeled “registered” is selected. In the following description, the authentication application of the mobile terminal 4 is also referred to simply as an authentication application.

When the user U registers with the authentication server 1, the authentication application displays the user registration screen shown in FIG. 5. FIG. 5 shows names of the services provided by each of the plurality of authentication servers 1. The user U selects the service for which the user wants to register as a user with the authentication server 1 by selecting the name of the service on the screen shown in FIG. 5. When the service is selected, the authentication application makes a user registration request to the application server 2 corresponding to said service.

When the registration requesting part 221 receives the user registration request from the authentication application, the registration requesting part 221 sends a login form, which is a page that receives user ID input, to the mobile terminal 4 to acquire first registration request information including the user ID inputted in the login form.

Specifically, when the registration requesting part 221 receives the user registration request from the authentication application, the registration requesting part 221 sends the login form for receiving the input of the user ID and a password to the mobile terminal 4 (step S2). The login form is embedded with an address for acquiring a script, from the authentication server 1, for hashing the user ID and acquiring an ID for notification. The ID for notification is identification information for notification, which is to be used when sending a push notification to the mobile terminal 4. The script is, for example, JavaScript (registered trademark). The application server 2 manages the login form and a service ID as service identification information in association with each other. Here, the service ID is identification information that identifies the application server 2 and is a character string having a predetermined length.

When the mobile terminal 4 receives the login form, the authentication application displays said login form on a display (not shown in figures) of the mobile terminal 4 (step S3). When the authentication application displays the login form on the display, the authentication application sends a script acquisition request to the authentication server 1 on the basis of the address for acquiring the script from the authentication server 1 (step S4). When the controller 12 of the authentication server 1 receives the script acquisition request from the mobile terminal 4, the controller 12 sends the script to the mobile terminal 4 (step S5).

The authentication application receives the input of the user ID and the password from the user U via the login form (step S6). When the user ID is inputted, the authentication application hashes the user ID on the basis of the script received from the authentication server 1 (step S7). In FIG. 3, the hashed user ID is referred to as h (user ID). Further, the authentication application acquires the ID for notification.

The login form is provided with a send button for sending the user ID and the password to the application server 2. When the send button is pressed, the authentication application sends the first registration request information including the user ID, the user ID hashed on the basis of the script, the password, and the ID for notification to the application server 2 by the HTTPS POST method (step S8). The registration requesting part 221 acquires the first registration request information.

The registration requesting part 221 performs password authentication on the basis of the user ID and the password included in the first registration request information acquired from the mobile terminal 4. The storage 21 of the application server 2 stores password authentication information associating a user ID and a password. If the user ID and the password included in the first registration request information are stored in association with each other in the storage 21, the registration requesting part 221 determines that the password authentication has been successful.

If the password authentication is successful, the registration requesting part 221 sends second registration request information to the authentication server 1 by the HTTPS POST method (step S9). The second registration request information includes the hashed user ID, the ID for notification, and the service ID associated with the login form, and requests registration of the user U (step S9). The biometric authentication instructing part 121 of the authentication server 1 receives the second registration request information from the application server 2. In this way, user IDs are not handled as they are in the authentication server 1, and therefore the leakage of user IDs from the authentication server 1 is prevented.

When the biometric authentication instructing part 121 receives the second registration request information, the biometric authentication instructing part 121 identifies the application ID associated with the service ID included in the second registration request information (step S10). Specifically, the storage 11 stores service IDs and application IDs in association with each other, and the biometric authentication instructing part 121 identifies the application ID associated with the received service ID. The application ID is, for example, information that identifies the application server 2, and is used in the authentication application to identify the service for which the biometric authentication is requested.

When the biometric authentication instructing part 121 identifies the application ID, the biometric authentication instructing part 121 sends a push notification including the second instruction information that instructs performance of the biometric authentication corresponding to the service ID included in the second registration request information using the ID for notification included in the second registration request information (step S11). Here, the second instruction information includes the application ID and the hashed user ID.

When the mobile terminal 4 receives the second instruction information, the authentication application registers the user with the authentication server 1 using, for example, a processing procedure corresponding to FIDO UAF.

Specifically, the authentication application sends a facet ID acquisition request to the authentication server 1 (step S12). When the authentication server 1 receives the facet ID acquisition request, the authentication server 1 sends a facet ID to the mobile terminal 4 (step S13). Here, the facet ID is used to confirm the validity of the authentication application (client platform).

The authentication application verifies the received facet ID (step S14). Then, the authentication application sends information indicating the user registration request to the authentication server 1 (step S15). The information indicating the user registration request includes the application ID and the hashed user ID.

A connection point A, a connection point B, and a connection point C in FIG. 3 are respectively connected to the connection point A, the connection point B, and the connection point C in FIG. 4. The process shown in the sequence diagram of FIG. 4 will be described below.

When the biometric authentication instructing part 121 of the authentication server 1 receives the information indicating the user registration request, the biometric authentication instructing part 121 generates challenge information, which includes a random string of characters. Further, the biometric authentication instructing part 121 selects policy information to be used for selecting an authentication method for biometric authentication. The biometric authentication instructing part 121 sends the generated challenge information and the selected policy information to the mobile terminal 4 (step S16).

When the mobile terminal 4 receives the challenge information and the policy information, the authentication application selects the authentication method for biometric authentication on the basis of said policy information (step S17).

The authentication application receives biometric information from the user of the mobile terminal 4 on the basis of the selected authentication method (step S18). For example, the authentication application receives fingerprint information indicating fingerprints of the user U as the biometric information.

The authentication application verifies the biometric information on the basis of the biometric information registered by the user U in the authentication application in advance and the biometric information received in step S18 (step S19).

When the authentication application verifies that the biometric information received in step S18 is valid, the authentication application generates a secret key for authentication corresponding to the application ID, a public key for authentication, and a key ID for identifying these keys (step S20).

The authentication application signs the generated public key for authentication, the key ID, an Attestation Cert, and an Authenticator Attestation ID (AAID) using the private key of the certificate for authentication registered in advance in the authentication application, and generates signature data (step S21). The authentication application sends the generated signature data to the authentication server 1 (step S22).

When the verifying part 122 receives the signature data indicating the authentication result of the biometric authentication corresponding to the second instruction information from the mobile terminal 4, the verifying part 122 verifies the validity of the signature data (step S23). Specifically, the storage 11 stores a public key of the certificate for authentication registered in the authentication application, and the verifying part 122 verifies whether or not the received signature data is valid using said public key.

When the signature data indicating the authentication result of the biometric authentication corresponding to the second instruction information is verified to be valid, the result sending part 123 of the authentication server 1 registers the user U by storing a) the hashed user ID, the application ID, and the ID for notification included in the second registration request information and b) the public key for authentication and the key ID included in the signature data in association with each other in the storage 11 (step S24).

The result sending part 123 sends a registration result of the user U to the mobile terminal 4 and the application server 2. For example, the result sending part 123 sends the registration result in response to acquiring a request for acquiring the registration result of the user U from the application server 2 (steps S25 and S26). Further, in response to the registration of the user U, the result sending part 123 sends the registration result to the mobile terminal 4 that sent the second instruction information (step S27). When the mobile terminal 4 receives the registration result, the authentication application adds the service registered with the authentication server 1 to the screen shown in FIG. 6.

It should be noted that the processing relating to the user registration shown in steps S13 to S24 in the sequence diagrams shown in FIGS. 3 and 4 corresponds to FIDO UAF, but the present disclosure is not limited thereto, and the user registration may be performed by other processing procedures.

### [User Authentication]

In the embodiment, when the authentication requesting part 223 of the application server 2 receives the authentication request for the user U from the terminal 3 used by the user U, the authentication requesting part 223 sends the biometric authentication request information to the authentication server 1. The biometric authentication request information includes the service ID and requests the biometric authentication for the user U.

When the biometric authentication instructing part 121 of the authentication server 1 receives the biometric authentication request information, the biometric authentication instructing part 121 instructs the mobile terminal 4, which is possessed by the user U and capable of performing the biometric authentication, to perform the biometric authentication corresponding to the service ID included in the biometric authentication request information. When the verifying part 122 receives the authentication result of the biometric authentication from the mobile terminal 4, the verifying part 122 verifies the validity of said authentication result. When the authentication result of the biometric authentication is verified to be valid, the result sending part 123 determines that the user U has been successfully authenticated and sends the authentication result to the application server 2 that sent the biometric authentication request information.

The providing part 224 of the application server 2 receives the authentication result of the biometric authentication from the authentication server 1 and provides the function related to the application to the terminal 3, when the authentication result indicates that the biometric authentication was successful.

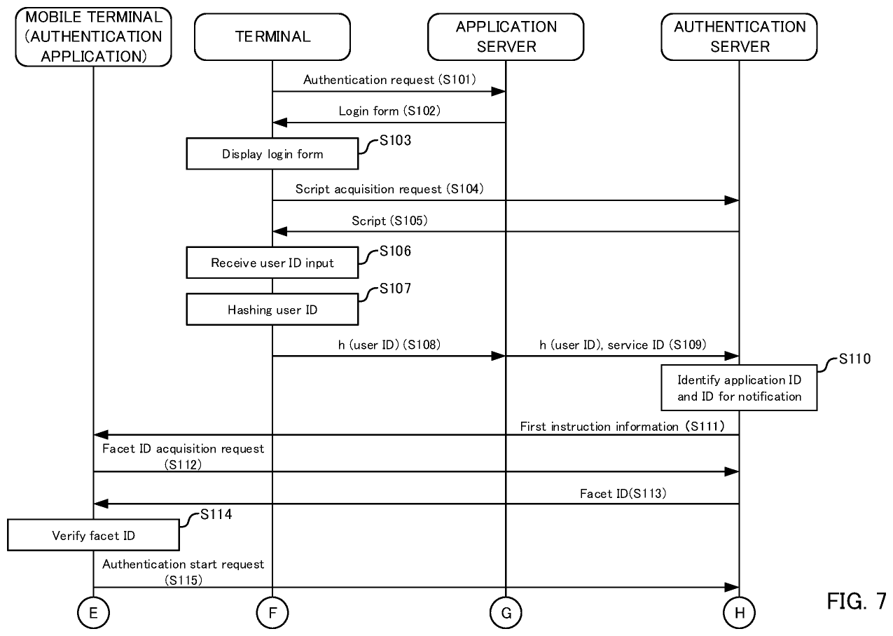

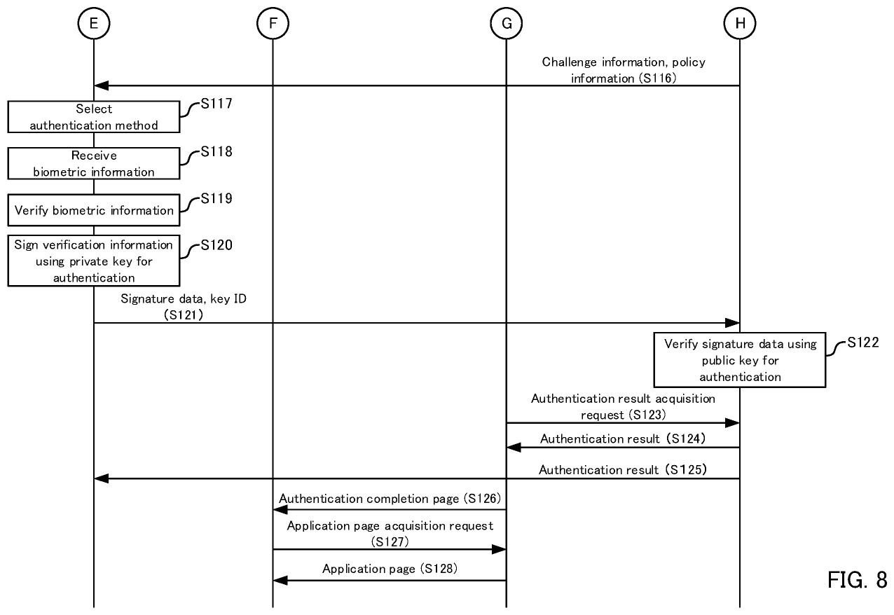

The details of the function of the authentication server 1 to authenticate the user U will be described below, along a sequence in the authentication system S. FIGS. 7 and 8 are sequence diagrams showing processing when authenticating the user U in the authentication system S according to the embodiment.

First, when the authentication requesting part 223 of the application server 2 receives the authentication request from the terminal 3 (step S101), the authentication requesting part 223 sends the login form to the terminal 3 (step S102). The login form includes an address of the authentication server 1 which is an address in JavaScript, serving as a script for hashing the user ID. The application server 2 manages the login form and the service ID in association with each other.

When the terminal 3 receives the login form, the terminal 3 displays the login form on a display (not shown in figures) of the terminal 3 (step S103). When the login form is displayed on the display, the terminal 3 sends the script acquisition request to the authentication server 1 on the basis of the address for acquiring the script from the authentication server 1 (step S104). When the controller 12 of the authentication server 1 receives the script acquisition request from the terminal 3, the controller 12 sends the script to the terminal 3 (step S105).

The terminal 3 receives the user ID input from the user U via the login form (step S106). It should be noted that, since the biometric authentication is used instead of the password for authenticating the user U, the login form does not receive a password input. When the user ID is inputted, the terminal 3 hashes said user ID on the basis of the script received from the authentication server 1 (step S107).

The login form is provided with a send button for sending the user ID to the application server 2. When the send button is pressed, the terminal 3 sends the user ID and the hashed user ID to the application server 2 by the HTTPS POST method (step S108). The authentication requesting part 223 acquires the user ID and the hashed user ID from the terminal 3.

When the authentication requesting part 223 acquires the user ID and the hashed user ID from the terminal 3, the authentication requesting part 223 references the storage 21 to determine whether or not said user ID is stored. When the authentication requesting part 223 determines that the user ID acquired from the terminal 3 is stored in the storage 21, the authentication requesting part 223 requires the authentication server 1 to biometrically authenticate the user U corresponding to said user ID. Specifically, the authentication requesting part 223 requests the authentication server 1 to biometrically authenticate the user U by sending, to the authentication server 1, the biometric authentication request information including the hashed user ID and the service ID associated with the login form sent to the terminal 3 (step S109).

The biometric authentication instructing part 121 of the authentication server 1 receives the biometric authentication request information from the terminal 3. When the biometric authentication instructing part 121 receives the biometric authentication request information, the biometric authentication instructing part 121 identifies the application ID and the ID for notification.

Specifically, the biometric authentication instructing part 121 references the storage 11 to identify the ID for notification associated with the hashed user ID and the service ID included in the biometric authentication request information. Further, when the biometric authentication instructing part 121 receives the biometric authentication request information, the biometric authentication instructing part 121 references the storage 11 and identifies the application ID associated with the service ID included in the biometric authentication request information.

The biometric authentication instructing part 121 sends, to the mobile terminal 4, a push notification including the first instruction information that instructs performance of the biometric authentication corresponding to the service ID, on the basis of the identified ID for notification (step S111). Here, the first instruction information includes the application ID and the hashed user ID.

When the authentication application of the mobile terminal 4 receives the first instruction information, the authentication application performs the biometric authentication according to, for example, the processing procedure corresponding to FIDO UAF.

Specifically, the authentication application sends the facet ID acquisition request to the authentication server 1 (step S112). When the authentication server 1 receives the facet ID acquisition request, the authentication server 1 sends the facet ID to the mobile terminal 4 (step S113).

The authenticating application verifies the received facet ID (step S114). Then, the authentication application sends information indicating an authentication start request to the authentication server 1 (step S115). It is assumed that the information indicating the authentication start request includes the application ID and the hashed user ID.

A connection point E, a connection point F, and a connection point G in FIG. 7 are respectively connected to the connection point E, the connection point F, and the connection point G in FIG. 8. The process shown in the sequence diagram of FIG. 8 will be described below.

When the biometric authentication instructing part 121 of the authentication server 1 receives the authentication start request, the biometric authentication instructing part 121 generates the challenge information, which includes a random string of characters. The biometric authentication instructing part 121 selects the policy information to be used for selecting the authentication method for biometric authentication. The biometric authentication instructing part 121 sends the generated challenge information and the selected policy information to the mobile terminal 4 (step S116).

When the mobile terminal 4 receives the challenge information and the policy information, the authentication application selects the authentication method for biometric authentication on the basis of said policy information (step S117).

The authentication application receives the biometric information from the user of the mobile terminal 4 on the basis of the selected authentication method (step S118).

The authentication application verifies the biometric information on the basis of a) the biometric information registered in advance by the user U in the authentication application and b) the biometric information received in step S118 (step S119).

When the authentication application verifies that the biometric information received in step S118 is valid, the authentication application signs a verification result and the challenge information using the private key for authentication corresponding to the application ID included in the first instruction information to generate the signature data (step S120). The authentication application sends the generated signature data to the authentication server 1 as the authentication result of the biometric authentication corresponding to the second instruction information, and sends the key ID corresponding to the private key for authentication to the authentication server 1 (step S121).

When the verifying part 122 of the authentication server 1 receives the signature data indicating the authentication result of the biometric authentication corresponding to the second instruction information from the mobile terminal 4, the verifying part 122 verifies the validity of the signature data (step S122). Specifically, the verifying part 122 references the storage 11 to identify the public key for authentication associated with the key ID received together with the signature data. The verifying part 122 verifies whether or not the received signature data is valid using the identified public key for authentication.

The result sending part 123 sends the authentication result of the user U to the mobile terminal 4 and the application server 2. Specifically, the providing part 224 of the application server 2 sends a request for acquiring the authentication result of the user U to the authentication server 1 (step S123). The result sending part 123 sends the authentication result to the application server 2 in response to acquiring the request for acquiring the authentication result of the user U (step S124). Further, in response to having authenticated the user U, the result sending part 123 sends the authentication result to the mobile terminal 4 that sent the first instruction information (step S125).

The providing part 224 of the application server 2 provides the function related to the application to the terminal 3 when the authentication result of the biometric authentication received from the authentication server 1 indicates that the biometric authentication was successful. Specifically, when the authentication result of the biometric authentication received from the authentication server 1 indicates that the biometric authentication was successful, the providing part 224 sends an authentication completion page indicating that the biometric authentication was successful to the terminal 3 (step S126). Here, the authentication completion page shows information indicating that authentication was successful, and an OK button is provided for requesting the application server 2 to provide the function of the application provided by the application server 2.

The terminal 3 displays the received authentication completion page on the display. When the OK button is pressed on the authentication completion page, the terminal 3 sends an application page acquisition request to the application server 2 (step S127). It should be noted that the application page acquisition request may be made by redirection. When the providing part 224 of the application server 2 receives the application page acquisition request, the providing part 224 sends the application page to the terminal 3 (step S128).

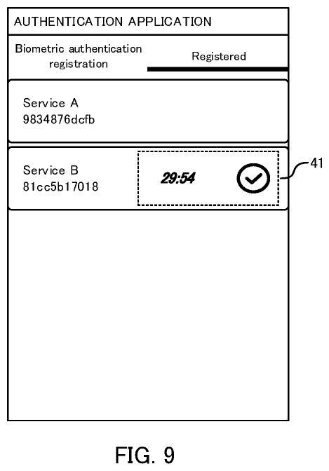

If the authentication result indicates that the biometric authentication was successful, the result sending part 123 may cause the terminal 3 or the mobile terminal 4 to display information indicating that the user has been successfully authenticated. For example, when the authentication result indicates that the biometric authentication was successful, the result sending part 123 causes the terminal 3 or the mobile terminal 4 to display information indicating that the user U has been successfully authenticated for a predetermined period of time. FIG. 9 illustrates the mobile terminal 4 displaying the information indicating that the user U has been successfully authenticated. In FIG. 9, it can be confirmed that an authentication success image, which is an image indicating that the user U has been successfully authenticated, is displayed in an area 41 corresponding to a service B, as information indicating that the authentication for the user U corresponding to the service B was successful. In addition, it can be confirmed that the area 41 shows the period of time for which the information indicating successful authentication is displayed, that is, the validity period of the authentication.

[A Push Notification to the Mobile Terminal 4 that has a Trusted Relationship with the Terminal 3]

When the user authentication is performed according to the embodiment, there is a problem that, if the user U inputs a user ID of a user different from the user himself/herself in the login form, a push notification will be sent to the mobile terminal possessed by said different user. Therefore, the biometric authentication instructing part 121 of the authentication server 1 according to the embodiment determines whether the terminal 3 and the mobile terminal 4 are in a trusted relationship state in which they are used by the same user U, and when the terminal 3 and the mobile terminal 4 are determined to be in the trusted relationship state, the biometric authentication instructing part 121 sends the push notification including the first instruction information. The following is an example of sending the push notification including the first instruction information to the mobile terminal 4, which is in the trusted relationship with terminal 3.

First, the mobile terminal 4 and the authentication server 1 share a public key for generating a one-time password. For example, the result sending part 123 of the authentication server 1 generates a public key for generating a password in response to having registered the user U. The result sending part 123 stores the generated public key in association with the hashed user ID and the application ID, and sends the registration result and said public key to the mobile terminal 4. When the user U is registered with the authentication server 1, the mobile terminal 4 stores the received public key in association with the service for which the user is registered. Thus, the public key is shared between the mobile terminal 4 and the authentication server 1.

The authentication application of the mobile terminal 4 displays the one-time password corresponding to each of the plurality of services on the registered service screen showing the services for which the user registration has been performed as shown in FIG. 6. For example, the authentication application of the mobile terminal 4 generates the one-time password at predetermined intervals on the basis of a) the public key for generating the password and b) the current time, and displays the one-time password on the display of the mobile terminal 4.

The authentication requesting part 223 receives the authentication request for the user U by receiving the user ID and the one-time password from the terminal 3. For example, the authentication requesting part 223 sends, to the terminal 3, the login form that receives an input of the user ID and the one-time password to receive the user ID and the one-time password from the terminal 3. The authentication requesting part 223 sends the biometric authentication request information including the user ID and the one-time password to the authentication server 1.

When the biometric authentication instructing part 121 receives the biometric authentication request information from the application server 2, the biometric authentication instructing part 121 generates the one-time password on the basis of a) the public key for generating a password and b) the current time. Then, the biometric authentication instructing part 121 determines whether or not the terminal 3 and the mobile terminal 4 are in the trusted relationship state on the basis of whether or not the generated one-time password matches the one-time password included in the biometric authentication request information. When the generated one-time password matches the one-time password included in the biometric authentication request information, the biometric authentication instructing part 121 determines that the terminal 3 and the mobile terminal 4 are in the trusted relationship state and sends the first instruction information to the mobile terminal 4.

It should be noted that, when the user U is successfully authenticated after the one-time password is inputted, the terminal 3 may store the user ID hashed on the basis of the user ID inputted in the login form. For example, when the providing part 224 of the application server 2 sends the authentication completion page indicating that the biometric authentication was successful to the terminal 3, the providing part 224 embeds the address of the script for storing the hashed user ID in the authentication completion page, thereby causing the terminal 3 to acquire said script when the authentication completion page is displayed on the terminal 3. The terminal 3 stores the hashed user ID as cookie information corresponding to the login form on the basis of the acquired script.

When the authentication requesting part 223 receives the authentication request for the user U from the terminal 3, the authentication requesting part 223 determines whether or not the hashed user ID is stored in the terminal 3. Then, when the authentication requesting part 223 determines that the hashed user ID is stored in the terminal 3, the authentication requesting part 223 acquires the hashed user ID from the terminal 3 without receiving the input of the user ID through the login form. The authentication requesting part 223 sends the biometric authentication request information including said hashed user ID, the service ID associated with the login form, and information indicating that the user ID was automatically acquired to the authentication server 1.

When the biometric authentication request information received from the application server 2 includes the information indicating that the user ID was automatically acquired, the biometric authentication instructing part 121 determines that the terminal 3 and the mobile terminal 4 are in the trusted relationship state, and sends the first instruction information to the mobile terminal 4.

Thus, the authentication system S can omit the user ID input and reduce the operation amount of the user related to the user authentication after the trusted relationship is established between the terminal 3 and the mobile terminal 4.

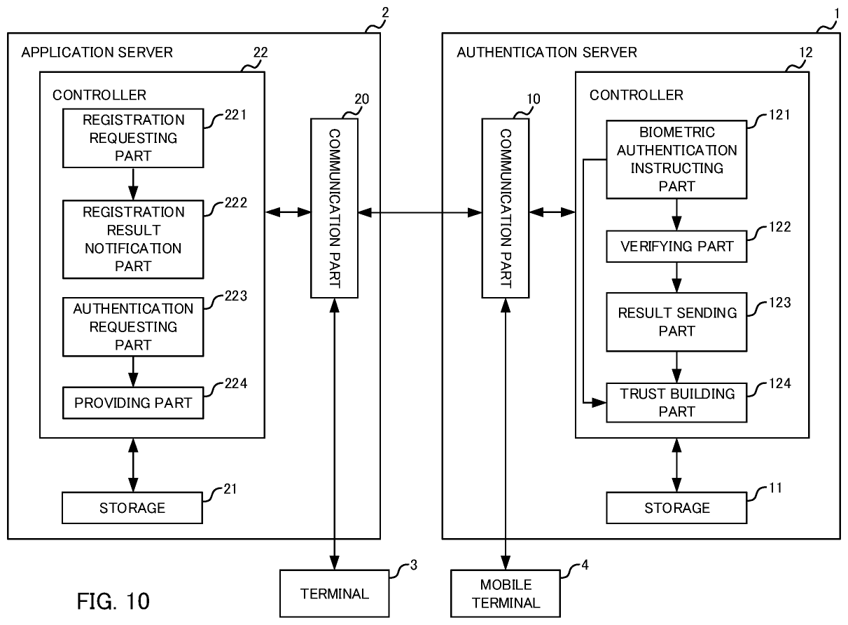

Further, the authentication server 1 may build the trusted relationship state between the terminal 3 and the mobile terminal 4 using other methods. FIG. 10 schematically shows a variation of each functional configuration of the authentication server 1 and the application server 2 of the embodiment. As shown in FIG. 10, the authentication server 1 further includes a trust building part 124.

When the authentication server 1 acquires the biometric authentication request information, the trust building part 124 causes the terminal 3 and the mobile terminal 4 to communicate with each other via the authentication server 1 on the basis of predetermined channel identification information, and receives from the mobile terminal 4 an indication of whether or not the terminal 3 and the mobile terminal 4 are in the trusted relationship. For example, the login form sent to the terminal 3 at the time of user authentication includes an address of a connection script for connecting the authentication server 1 and the terminal 3 in a communicable manner by the predetermined channel identification information at the timing when the user ID is inputted and the biometric authentication request information is sent to the authentication server 1, and the terminal 3 and the authentication server 1 are connected in a communicable manner on the basis of the script.

In addition, the trust building part 124 notifies the mobile terminal 4 about a predetermined channel ID at the time of sending the push notification to the mobile terminal 4. Then, the trust building part 124 connects the terminal 3 and the mobile terminal 4 via the authentication server 1 in a communicable manner using a) Node.js, which is a JavaScript environment running on the server, and b) Web Socket for bi-directional communication between terminals via the authentication server 1.

The trust building section 124 displays a selection button on the mobile terminal 4 for selecting whether or not the terminal 3 and the mobile terminal 4 are in the trusted relationship, and receives an indication of whether or not the terminal 3 and the mobile terminal 4 are in the trusted relationship. If the trust building part 124 receives an indication that the terminal 3 and the mobile terminal 4 are in the trusted relationship from the mobile terminal 4, the trust building part 124 stores the predetermined channel identification information in the terminal 3 and the mobile terminal 4 as the trusted relationship information. Further, the trust building part 124 stores the hashed user ID in the terminal 3.

When the login form is displayed on the terminal 3 in a state in which the predetermined channel identification information is stored in the terminal 3 and the mobile terminal 4, the terminal 3 and the mobile terminal 4 are connected in a communicable manner via the authentication server 1 on the basis of the predetermined channel identification information stored therein. For example, the connection script includes a code for communicating with the mobile terminal 4 via the authentication server 1 when the predetermined channel identification information is stored in the terminal 3, and the terminal 3 connects with the mobile terminal 4 in a communicable manner via the authentication server 1 on the basis of the code.

When the predetermined channel identification information (trusted relationship information) is stored in the terminal 3 and the mobile terminal 4, and the terminal 3 and the mobile terminal 4 are connected in a communicable manner via the authentication server 1, the biometric authentication instructing part 121 determines that the terminal 3 and the mobile terminal 4 are in the trusted relationship state, and sends the push notification including the first instruction information to said mobile terminal 4.

Specifically, first, when the terminal 3 and the mobile terminal 4 are connected in a communicable manner on the basis of the predetermined channel identification information, the authentication requesting part 223 acquires the user ID from the terminal 3 in response to the mobile terminal 4 being operated. For example, the screen shown in FIG. 6 is displayed on the mobile terminal 4, and in response to the service on said screen being selected, the terminal 3 is notified that the service was selected. When the terminal 3 is notified that the service has been selected, the terminal 3 sends the hashed user ID stored in the storage corresponding to said service to the application server 2.

The authentication requesting part 223 of the application server 2 sends, to the authentication server 1, the biometric authentication request information including i) the hashed user ID, ii) the service ID associated with the login form sent to the terminal 3, and iii) the information indicating that the user ID was automatically acquired.

When the biometric authentication request information received from the application server 2 includes the information indicating that the user ID was automatically acquired, the biometric authentication instructing part 121 determines that the terminal 3 and the mobile terminal 4 are in the trusted relationship state and sends the first instruction information to said mobile terminal 4.

In this way, the authentication system S can prevent the push notification from being sent to the mobile terminal possessed by a user different from the user U.

It should be noted that the processing relating to the biometric authentication shown in steps S112 to S122 in the sequence diagrams shown in FIGS. 7 and 8 corresponds to FIDO UAF, but the present disclosure is not limited thereto, and biological authentication corresponding to other processing procedures may be performed.

### Effects Realized by the Authentication System S According to the Embodiment

As described above, according to the authentication system S according to the embodiment, when the application server 2 receives the authentication request for the user U from the terminal 3 used by the user U, the application server 2 sends the biometric authentication request information to the authentication server 1 to request the biometric authentication to the authentication server 1, the biometric authentication request information including the service ID for identifying the application server 2 and requesting the biometric authentication for the user U. When the authentication server 1 receives the biometric authentication request information, the authentication server 1 sends, to the mobile terminal 4 which is possessed by the user U and capable of performing the biometric authentication, the push notification including the first instruction information that instructs performance of the biometric authentication corresponding to the service ID included in the biometric authentication request information, and receives the authentication result of the biometric authentication from the mobile terminal 4. When the authentication server 1 verifies that the authentication result is valid, the authentication server 1 sends the authentication result to the application server 2 that sent the biometric authentication request information. The application server 2 receives the authentication result of the biometric authentication from the authentication server 1, and provides the terminal 3 with the function related to the application when the authentication result indicates that the biometric authentication was successful.

Thus, when the biometric authentication is used to authenticate the user U in the application server 2, the operator of the application server 2 only needs to implement, in the application server 2, i) a function of performing processing related to the biometric authentication request and ii) a function of providing the function related to the application to the terminal 3 when the authentication result is received. In this way, the operator of the application server 2 can easily handle the result of biometric authentication in the application server 2. Therefore, the authentication system S can easily handle the result of biometric authentication in the application server 2.

### [Variation 1]

The present disclosure has been explained on the basis of the embodiments, but the technical scope of the present disclosure is not limited to the scope explained in the above embodiments, and it is possible to make various changes and modifications within the scope of the disclosure. For example, in the above-described embodiment, the authentication server 1 sends, to the mobile terminal 4, the push notification including the first instruction information that instructs performance of the biometric authentication in response to receiving the biometric authentication request from the application server 2 to cause the mobile terminal 4 perform the biometric authentication, but the present disclosure is not limited thereto.

For example, the biometric authentication in the mobile terminal 4 may be performed before receiving the biometric authentication request from the terminal 3. In this instance, the user U selects the service for which the biometric authentication is to be performed on the screen shown in FIG. 6. The mobile terminal 4 stores the service name, the application ID, and the hashed user ID in advance in association with each other. These pieces of information are encrypted using Advanced Encryption Standard (AES)-Galois/Counter Mode (GCM) and stored in a secure area compliant with Trusted Execution Environment (TEE). As shown in FIG. 6, the mobile terminal 4 displays the service name and a unique code for identifying the service, and receives an operation to select the service. The unique code is generated on the basis of the application ID and the hashed user ID, for example. The authentication application sends, to the authentication server 1, the authentication start request including the application ID and the hashed user ID in a similar manner as in the processing of step S115 shown in FIG. 7, in response to the service is being selected. Then, the processing from steps S116 to S122 shown in FIG. 8 is executed between the mobile terminal 4 and the authentication server 1.

Before the authentication server 1 receives the biometric authentication request information, the verifying part 122 of the authentication server 1 receives the authentication result of the biometric authentication performed in the mobile terminal 4 from the mobile terminal 4 and verifies the validity of the authentication result. When the verifying part 122 verifies that the authentication result is valid, the verifying part 122 stores prior authentication information associating the hashed user ID included in the authentication start request, the application ID, and the authentication result in the storage 11 for a predetermined period of time (for example, five minutes).

The result sending part 123 sends the authentication result to the application server 2 that sent the biometric authentication request information in response to the authentication server 1 receiving the biometric authentication request information, after the verifying part 122 verifies that the authentication result is valid. Specifically, when the result sending part 123 receives the biometric authentication request information, the result sending part 123 identifies the application ID associated with the service ID included in the biometric authentication request information. Then, when the prior authentication information corresponding to the hashed user ID included in the biometric authentication request information and the identified application ID are stored in the storage 11, the result sending part 123 sends the authentication result included in the prior authentication information to the application server 2 that sent the biometric authentication request information.

In this way, the user U can receive the function of the application server 2 by completing the authentication in advance.

### [Variation 2]

The authentication system S may be used when a user enters an event venue. In this case, the user U registers as a user in advance with the application server 2 that provides the service corresponding to the event, prior to entry reception at the event venue. In this instance, it is assumed that the user ID and the password are associated with a ticket, and are notified to the user U when the ticket is issued, for example.

The user U authenticates the user U using the authentication system S at the event venue. When the authentication for the user U is successful, the result sending part 123 of the authentication server 1 causes the mobile terminal 4 of the user U to display the authentication success image indicating that the user U has been successfully authenticated for a predetermined period of time. The attendant who controls admission at the event venue permits admission of the user U by confirming that the authentication success image is displayed on the mobile terminal 4. It should be noted that, when the predetermined period of time has elapsed since the authentication success image was displayed, and said information is no longer displayed on the mobile terminal 4 of the user U, the user U performs the authentication again. In this manner, the authentication system S can prevent a third party from impersonating the ticket purchaser.

### [Variation 3]

In variation 2, the result sending part 123 causes the mobile terminal 4 to display the authentication success image when the authentication is successful, but the disclosure is not limited thereto. For example, the result sending part 123 may generate a QR code (registered trademark) indicating a token which is valid for a predetermined period of time on the basis of Time-based One-time Password (TOTP), and cause the mobile terminal 4 to display said QR code. For example, an admission control device that can read QR codes is installed at the event venue, and the user U lets the admission control device read the QR code displayed on the mobile terminal 4. The admission control device determines whether or not the token indicated by the QR code is valid, and displays the determination result on its own display. The attendant who controls admission at the event venue permits the admission of the user U by confirming that the determination result indicating that the token is valid is displayed on the admission control device. It should be noted that, when the admission control device determines that the token indicated by the QR code is valid, the admission control device may send a control signal, which is a signal to open the gate, to an admission gate to open the gate.

### [Variation 4]

In variations 2 and 3, the terminal 3 is possessed by the user, but the present disclosure is not limited thereto. For example, the terminal 3 may be a terminal used by the attendant who controls admission. When the login form is displayed on the terminal 3 and the user U inputs the user ID, the authentication server 1 sends the push notification to the mobile terminal 4 to biometrically authenticate the user U. If the biometric authentication for the user U is successful, the terminal 3 displays the information indicating that the biometric authentication for the user U was successful. The attendant who controls admission permits the admission of the user U when the information indicating that the biometric authentication for the user U was successful is displayed on the terminal 3.

It should be noted that, in the present variation, the user U inputs the user ID to the terminal 3, but the present disclosure is not limited thereto. For example, the phone number of the mobile terminal 4 possessed by the user U and the user ID may be stored in the application server 2 in association with each other. Then, the application server 2 may identify the user ID corresponding to the telephone number in response to an input of the telephone number to the terminal 3, and request that the authentication server 1 biometrically authenticates the user corresponding to the user ID. In this case, the terminal 3 may receive an input of the last four digits of the telephone number, and the application server 2 may identify the user ID on the basis of said last four digits of the telephone number. If a plurality of phone numbers that match the last four digits of the inputted phone number is registered, the application server 2 may display a plurality of user IDs associated with these phone numbers on the terminal 3, and receive the selection of his/her own user ID from the user U.

### [Variation 5]

In addition, in the above embodiment, the terminal 3 and the mobile terminal 4 are different from each other, but the present disclosure is not limited thereto. The mobile terminal 4 may function as the terminal 3. Even if the user U owns only the mobile terminal 4, the user authentication can be performed by the same procedure as in the embodiment.

For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

What is claimed is:

1. An authentication system comprising:
a plurality of application providing devices that provides applications; and
an authentication apparatus that performs biometric authentication for a user who uses the applications, wherein
the application providing device includes
an authentication requesting part that sends biometric authentication request information to the authentication apparatus when a request for authentication for the user is received from a terminal, the biometric authentication request information including service identification information for identifying the application providing device and requesting biometric authentication for the user, and
a providing part that provides a function related to the application to the terminal when an authentication result of the biometric authentication is received from the authentication apparatus and the authentication result indicates that the biometric authentication was successful,
the authentication apparatus includes
a biometric authentication instructing part that sends a push notification including first instruction information to a mobile terminal, which is possessed by the user and capable of performing biometric authentication, when the biometric authentication request information is received, the first instruction information instructing performance of the biometric authentication corresponding to service identification information included in the biometric authentication request information,
a verifying part that receives the authentication result of the biometric authentication corresponding to the first instruction information from the mobile terminal and verifies the validity of the authentication result, and
a result sending part that sends the authentication result to the application providing device that sent the biometric authentication request information when the verification part verifies that the authentication result is valid.

2. The authentication system according to claim 1, wherein
the authentication apparatus further includes a storage that stores user identification information for identifying the user, the service identification information, and identification information for notification used for sending the push notification to the mobile terminal, in association with each other,
the authentication requesting part sends, to the authentication apparatus, biometric authentication request information including the user identification information and the service identification information, when the authentication requesting part acquires the user identification information from the terminal, and
the biometric authentication instructing part a) references the storage when the biometric authentication instructing part receives the biometric authentication request information, and b) sends the push notification including the first instruction information to the mobile terminal on the basis of the identification information for notification associated with the user identification information and the service identification information.

3. The authentication system according to claim 2, wherein
the storage stores the service identification information, the identification information for notification, and the user identification information being hashed, in association with each other,
the authentication requesting part sends the biometric authentication request information including the service identification information and the hashed user identification information to the authentication apparatus, when the authentication requesting part acquires the hashed user identification information from the terminal, and
the biometric authentication instructing part a) references the storage when the biometric authentication instructing part receives the biometric authentication request information, and b) sends the push notification including the first instruction information to the mobile terminal on the basis of the identification information for notification associated with the hashed user identification information and the service identification information.

4. The authentication system according to claim 3, wherein
the authentication requesting part sends a page that includes an address of a script for hashing the user identification information and receives an input of the user identification information, and acquires the hashed user identification information generated on the basis of the script acquired by the mobile terminal on the basis of the address, from the terminal.

5. The authentication system according to claim 2, wherein
the application providing device further includes a registration requesting part that sends second registration request information requesting registration of the user to the authentication apparatus when the registration requesting part acquires first registration request information indicating a registration request for the user to register with the authentication apparatus from the mobile terminal, the second registration request information including the user identification information, the identification information for notification, and the service identification information, and the first registration request information including the user identification information and the identification information for notification,
the biometric authentication instructing part sends a push notification including second instruction information that instructs performance of the biometric authentication corresponding to the service identification information included in the second registration request information to the mobile terminal, on the basis of the identification information for notification included in the second registration request information, when the biometric authentication instructing part receives the second registration request information,
the verifying part receives an authentication result of the biometric authentication corresponding to the second instruction information from the mobile terminal, and verifies the validity of the authentication result, and
the result sending part stores the user identification information, the service identification information, and the identification information for notification included in the second registration request information in association with each other in the storage, and sends a registration result of the user to the mobile terminal and the application providing device, when the verifying part verifies that the authentication result of the biometric authentication corresponding to the second instruction information is valid.

6. The authentication system according to claim 5, wherein
the registration requesting part sends a page that includes an address of a script for hashing the user identification information and receives an input of the user identification information, and acquires the first registration request information including the hashed user identification information generated on the basis of the script acquired by the mobile terminal on the basis of the address.

7. The authentication system according to claim 1, wherein
the biometric authentication instructing part determines whether or not the terminal and the mobile terminal are in a trusted relationship state indicating that they are used by the same user, and when the biometric authentication instructing part determines that the terminal and the mobile terminal are in the trusted relationship state, the biometric authentication instructing part sends the push notification including the first instruction information.

8. The authentication system according to claim 7, wherein
the mobile terminal and the authentication apparatus share a public key for generating a one-time password,
the mobile terminal generates the one-time password on the basis of the public key and displays the one-time password,
the authentication requesting part receives a request for authentication for the user by receiving the user identification information for identifying the user and the one-time password from the terminal, and sends the biometric authentication request information including the user identification information and the one-time password to the authentication apparatus, and
the biometric authentication instructing part generates a one-time password on the basis of the public key, and determines whether or not the terminal and the mobile terminal are in the trusted relationship on the basis of whether or not the generated one-time password matches the one-time password included in the biometric authentication request information, when the biometric authentication instructing part receives the biometric authentication request information.

9. The authentication system according to claim 8, wherein
the terminal stores the user identification information used for the authentication in the terminal if the user was successfully authenticated, and
the authentication requesting part acquires the user identification information from the terminal, and sends the biometric authentication request information including the user identification information and the service identification information to the authentication apparatus if the user identification information is stored in the terminal when the authentication requesting part receives the authentication request for the user from the terminal.

10. The authentication system according to claim 7, wherein
the authentication apparatus further includes a trust building part that, a) connects the terminal and the mobile terminal in a communicable manner via the authentication apparatus on the basis of predetermined channel identification information, b) receives an indication of whether or not the terminal and the mobile terminal are in a trusted relationship from the mobile terminal, and c) stores, when the trust building part receives the indication that the terminal and the mobile terminal are in the trusted relationship, trusted relationship information indicating that the terminal and the mobile terminal are in the trusted relationship, when the authentication apparatus acquires the biometric authentication request information, and
the biometric authentication instructing part determines that the terminal and the mobile terminal are in the trusted relationship state when the trusted relationship information is stored in the terminal and the mobile terminal, and sends the push notification including the first instruction information to the mobile terminal.

11. The authentication system according to claim 1, wherein
the verifying part receives the authentication result of the biometric authentication performed in the mobile terminal from the mobile terminal before the authentication apparatus receives the biometric authentication request information, and verifies the validity of the authentication result, and
the result sending part sends the authentication result to the application providing device that sent the biometric authentication request information, in response to receiving the biometric authentication request information after the verifying part verifies that the authentication result is valid.

12. The authentication system according to claim 1, wherein
the result sending part causes the terminal or the mobile terminal to display information indicating that the authentication for the user was successful when the authentication result indicates that the biometric authentication was successful.

13. The authentication system according to claim 12, wherein
the result sending part causes the terminal or the mobile terminal to display information indicating that the authentication for the user was successful for a predetermined period of time when the authentication result indicates that the biometric authentication was successful.

14. An authentication method performed by an authentication system including a plurality of application providing devices that provides applications and an authentication apparatus that authenticates a user using the applications, the authentication method comprising the steps of:
sending, when the application providing device receives an authentication request for the user from a terminal, biometric authentication request information including service identification information for identifying the application providing device and requesting biometric authentication for the user to the authentication apparatus;
sending a push notification to a mobile terminal which is possessed by the user and capable of performing biometric authentication, the push notification including first instruction information that instructs performance of the biometric authentication corresponding to service identification information included in the biometric authentication request information, when the authentication apparatus receives the biometric authentication request information;
receiving an authentication result of the biometric authentication corresponding to the first instruction information from the mobile terminal and verifying the validity of the authentication result by the authentication apparatus;
sending the authentication result to the application providing device that sent the biometric authentication request information, by the authentication apparatus, when the authentication apparatus verifies that the authentication result is valid; and
providing a function related to the application to the terminal when the application providing device receives the authentication result of the biometric authentication from the authentication apparatus and the authentication result indicates that the biometric authentication was successful.

15. An authentication apparatus that performs biometric authentication for a user, comprising:
a biometric authentication instructing part that, when receiving biometric authentication request information from the application providing device providing applications, sends a push notification to a mobile terminal, which is possessed by the user and capable of performing biometric authentication, the push notification including instruction information that instructs performance the biometric authentication corresponding to service identification information, the biometric authentication request information including the service identification information for identifying the application providing device providing applications and requesting biometric authentication for the user;
a verifying part that receives an authentication result of the biometric authentication corresponding to the instruction information from the mobile terminal and verifies the validity of the authentication result; and
a result sending part that, when the verifying part verifies that the authentication result is valid, sends the authentication result to the application providing device that sent the biometric authentication request information.
